(19) United States
(12) Patent Application Publication
(10) Pub. No.: US 2025/0353636 A1
(43) Pub. Date: Nov. 20, 2025

(54) WEB FEEDING SYSTEM FOR A LABELLING MODULE FOR PREPARING THE SPLICING OPERATION

(71) Applicant: SIDEL PARTICIPATIONS, OCTEVILLE-SURMER (FR)

(72) Inventors: Mattia GIULIANI, Mantova (IT); Vincenzo PAPARO, Mantova (IT); Giacomo PARADISO, Mantova (IT); Marco FERRI, Mantova (IT); Alberto BIANCHI, Parma (IT)

(21) Appl. No.: 18/873,101

(22) PCT Filed: Nov. 10, 2022
(86) PCT No.: PCT/EP2022/081391

§ 371 Date: Dec. 9, 2024

(51) Int. Cl. B65C 9/18; B25J 15/06; B65B 61/02; B65C 9/02

(52) U.S. Cl. CPC B65C 9/18; B25J 15/0616; B65B 61/025; B65C 9/02

(57) ABSTRACT

Described is a web feeding system for feeding a web of labelling material to a labelling module that includes a splicing device. The feeding system includes a positioning device for automatically positioning the web leading portion of the web in a splicing position with respect to the splicing device.

### TECHNICAL FIELD

The present invention relates to a support device for a reel of web of labelling material for labelling articles adapted to contain a pourable product, preferably a pourable food product.

The present invention also relates to a web feeding system for a labelling module for labelling articles adapted to contain a pourable food product, preferably a pourable food product.

### BACKGROUND ART

Labelling machines are known, which are commonly used to prepare, transport and apply labels onto articles, such as bottles, flacons or containers of this sort, destined to be filled with a pourable product, in particular a pourable food product.

Particularly widespread is the use of glued labels, i.e. portions of a labelling material that are cut at appropriate lengths from a web of labelling material initially wound in form of continuous strip around one or more storage reels and then sprinkled with glue. In detail, the web of labelling material is progressively unwound off the relative reel and then repeatedly cut to obtain successive labels of equal length, upon which glue is applied by gluing means, such as a gluing roller, spray or injector systems or the like. Eventually, the labels so obtained are conveyed and applied onto the respective articles to be labelled.

Particularly widespread are also labels of the tubular type, known as “sleeve labels” and obtained starting from a web of heat-shrinking film wound in form of a continuous strip around one or more storage reels; the sleeve labels are applied with a certain clearance on the respective articles and then heated in an oven to obtain their shrinking and perfect adhesion to the lateral surfaces of the articles themselves. These type of labels do not require the use of glue.

Regardless of the type of label used, a known labelling machine typically comprises:
a carousel rotatable around a vertical axis and configured to convey a plurality of articles along an horizontal, arc-shaped labelling path;
an inlet station, at which the articles to be labelled are received by the carousel;
an outlet station, at which the labelled articles exit the carousel; and
a labelling module, peripherally arranged relatively to the carousel and configured to prepare, transport and feed a plurality of labels to the carousel at an application station, in order to apply such labels to respective articles.

According to a well-known configuration, a labelling module typically comprises:
one or more support shafts for supporting in a rotatable manner one winding of the web of labelling material at a time, the winding being defined by a continuous strip initially wound in form of a reel;
a feed roller for unwinding the web off the relative reel and advance it along a feed path;
a plurality of guide rollers, which support, in use, the web progressively unwound from the reel and guide it, in use, along the feed path;
a cutting unit for repeatedly cut the web at a cutting station so as to separate a sequence of labels from the web itself; and
a label transfer device, for example a known vacuum drum configured to receive, retain and advance each label and to feed each label to the carousel, at the application station.

Furthermore, in case glued labels are used, the labelling module comprises at least one gluing roller arranged substantially tangent to the vacuum drum, in a position operatively downstream of the cutting unit and upstream of the application station, with respect to the direction of rotation of the vacuum drum, for spreading glue onto at least the (leading and trailing) edges of each single label, prior to their application onto the relative articles.

In the case of sleeve type labels, the labels are wound in a tube shape about respective forming mandrels advanced by the carousel and carrying at the top the articles to be labeled; the labels are then sealed at the overlapping ends; at this point, the mandrels are retracted back inside the base of the carousel thus allowing the insertion of the articles with clearance in the respective sleeve labels; subsequently, the containers with the “loose” labels applied thereon are sent to the heating oven to obtain heat-shrinking of the labels and perfect adhesion of the latter onto said articles.

Regardless of the type of labels used, the need is known in the field for automatically splicing the end (or final) portion of a first web wound in a first reel (reel in use) with the initial portion of a second web wound in a second reel (new reel), in order to avoid stopping the labelling machine every time a reel is spent, i.e. every time the web of such reel is finished.

In this regard, labelling machines of the known type comprise a well-known splicing device (or “splicer”) operatively arranged between the feeding unit and the guide rollers and configured to splice the end portion of the first web with the initial portion of the second web.

In detail, the splicing device typically comprises a pair of splicing members or “blocks”, each hinged to a fixed frame of the labelling module at a first portion thereof and movable in a pivotable manner between an opening position, in which it is spaced from the other block, and a closing position in which it is closer to the other block.

Each block comprises a retaining device, typically a vacuum pad fluidly connected to a known vacuum source, for receiving and retaining (by suction) the initial portion of the second web unwound from the second reel. In addition, each pad can support one first web being unwound from the respective reel, during the labelling process.

Once the initial portion of the second web is positioned on one of the pads, and once the first reel is spent or almost spent, the pads of each block are movable from a rest condition to a splicing condition to perform the splicing of such initial portion with the end portion of the first web.

Typically, an adhesive band is applied to the initial portion of the second web, for the firm joining to the first web, once the pads are controlled in the splicing position.

In use, before the splicing becomes necessary and while the first web is unwinding from the first reel during the labelling process, an operator manually moves the blocks into the opening position, grasps the initial portion, i.e. the free end flap, of the second web from the rest of the second reel, pulls such free end flap to unwind an initial portion of such second web, and places the free end flap onto the relative pad, which retains it by means of vacuum.

Hence, the correct positioning of the free end flap of the second web on the respective vacuum pad of the splicing device, which is a crucial variable for a correct labelling operation, is left to the ability of the operator.

Although the labelling modules of the type described above are functionally valid, the Applicant has observed that they are still open to further improvements, in particular as per the risk of positioning errors of the free end flap by the operator, as per the total time needed for the preparation of the splicing operation, and as per the increase in the automation degree of such operation.

### DISCLOSURE OF INVENTION

It is therefore an object of the present invention to provide a support device, a web feeding system and a method for feeding a web of labelling material to a labelling module, which are designed to meet at least one of the above-mentioned needs in a straightforward and low-cost manner.

This object is achieved by a web feeding system and a labelling machine as claimed in the appended claims.

### BRIEF DESCRIPTION OF THE DRAWINGS

Non-limiting embodiments of the present invention will be described by way of example with reference to the accompanying drawings, in which:

FIG. 1 is a schematic top view, with parts removed for clarity, of a labelling machine comprising a labelling module and a web feeding system according to the present invention;

FIG. 2 is a larger-scale lateral view, with parts removed for clarity, of the web feeding system of FIG. 1, in a first instant;

FIGS. 3 and 4 are larger-scale, perspective views, with parts removed for clarity, of part of the web feeding system of FIG. 1, in a second and a third instant, respectively;

FIGS. 5a-5c are larger-scale, schematic lateral views, with parts removed for clarity, of part of the web feeding system of FIG. 1, in a fourth instant, in a fifth instant and in a sixth instant, respectively; and

FIG. 6 is a perspective view of a web feeding unit according to the invention, which is part of the web feeding system according to the invention.

### BEST MODE FOR CARRYING OUT THE INVENTION

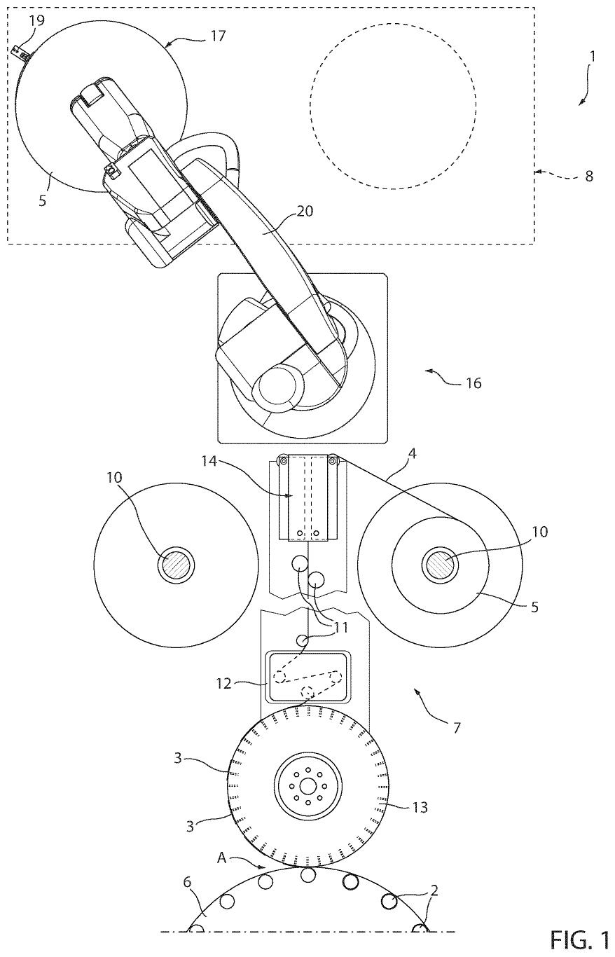

With reference to FIG. 1, number 1 indicates as a whole a labelling machine for labelling containers 2, such as bottles, flacons, cans or containers of this sort, adapted to contain a pourable product, preferably a pourable food product. The labelling machine 1 comprises a labelling module 7.

The labelling machine 1 comprises a conveyor 6 for conveying the containers 2. The machine 1 is configured so that the containers 2 are labelled by the labelling module 7 while being conveyed by the conveyor 6. The conveyor 6 can be a carousel.

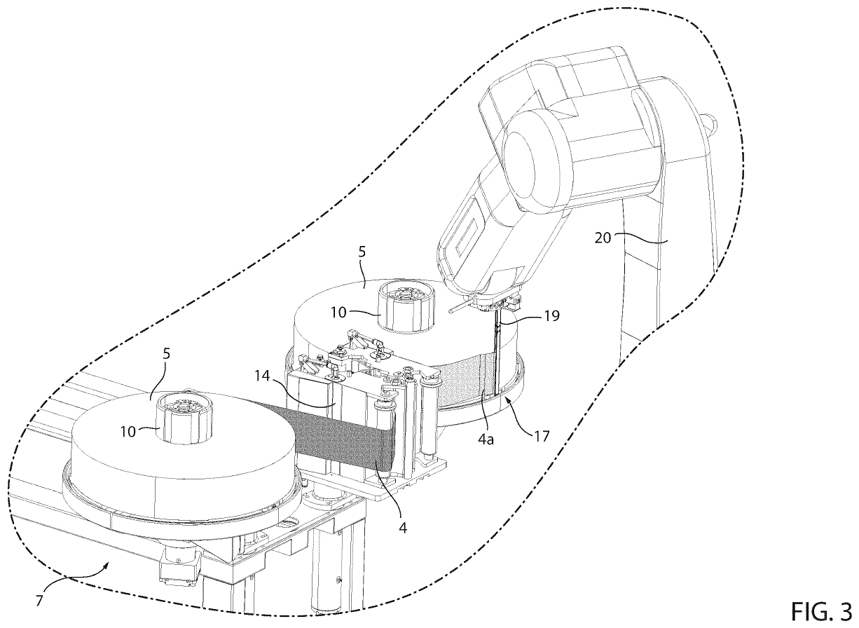

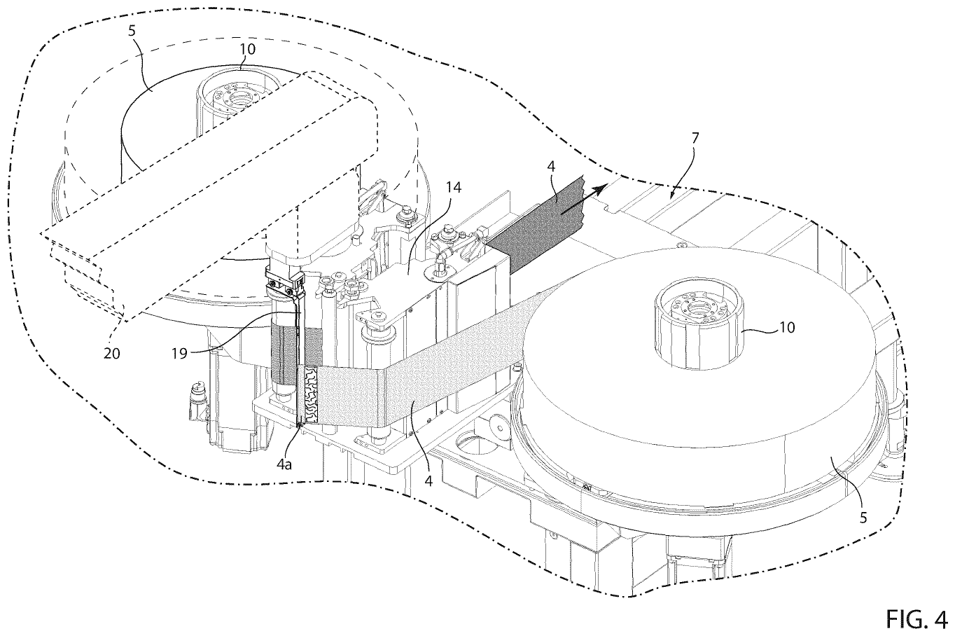

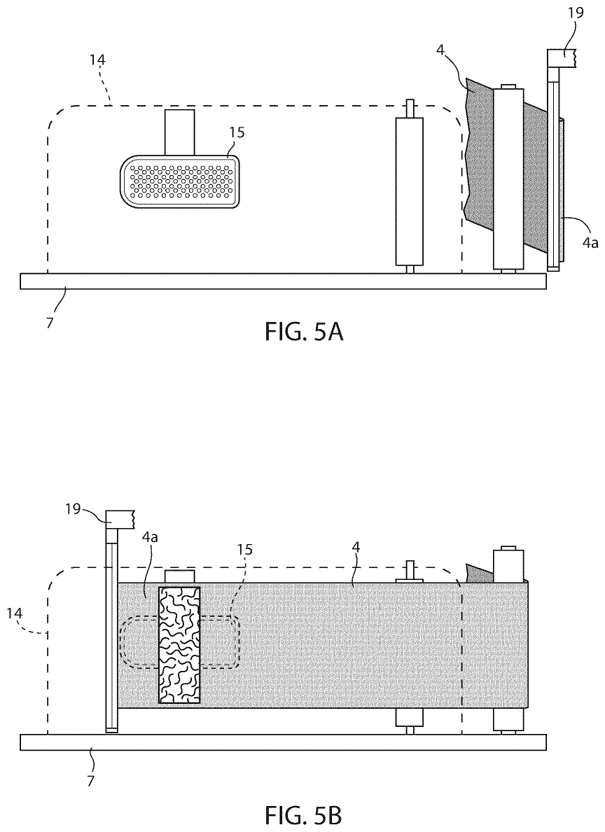

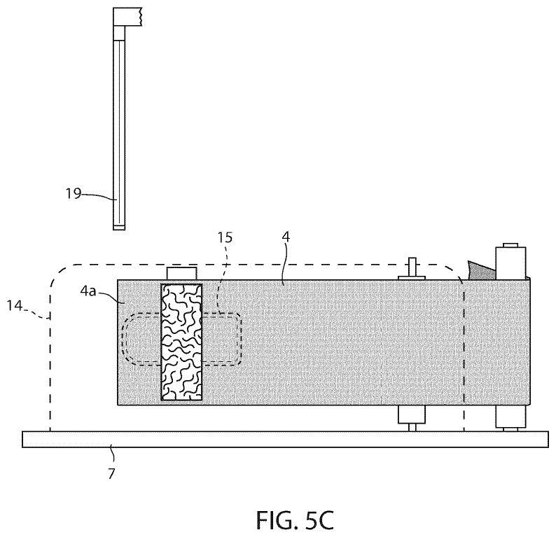

The labelling module 7 comprises a splicing device 14. The splicing device 14 is configured for splicing a web in use with a new web. The need of splicing arises when the web in use is about to be depleted. The web 4 which is indicated in FIGS. 1 and 3 is a web in use, which is about the be depleted. The web 4 which is indicated in FIGS. 4, 5A, 5B, and 5C, is the new web.

The machine 1 comprises a web feeding system 16. The web feeding system 16 is configured for feeding a web of labelling material to the labelling module 7.

The feeding system 16 comprises a web feeding unit 17. The feeding unit 17 comprises a support 18 for supporting a reel 5 of web 4. The feeding unit 17 comprises a gripper 19 for gripping a web leading portion 4a of the web 4 of the supported reel 5.

The gripper 19 is configured to be engaged with the support 18 and is configured to be disengaged from the support 18.

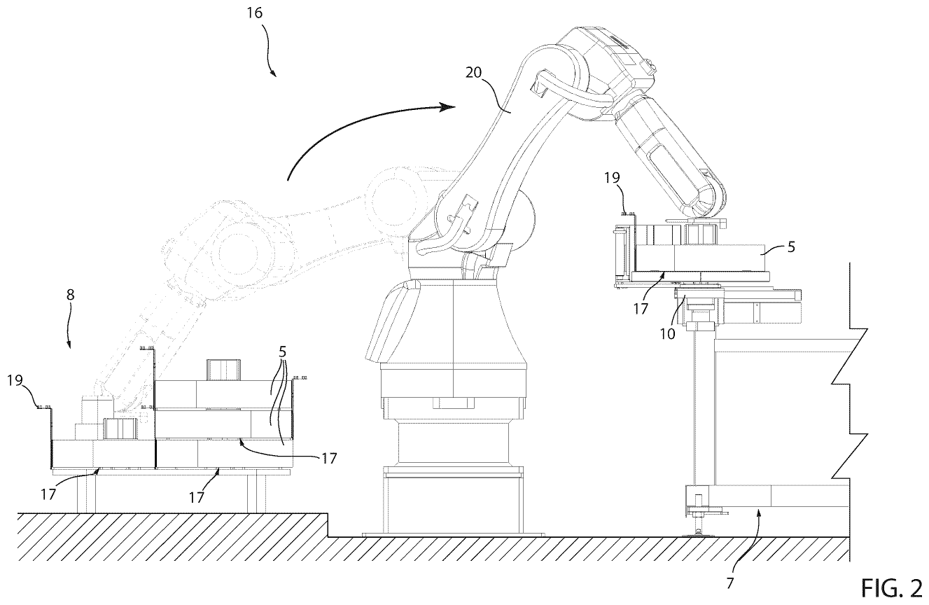

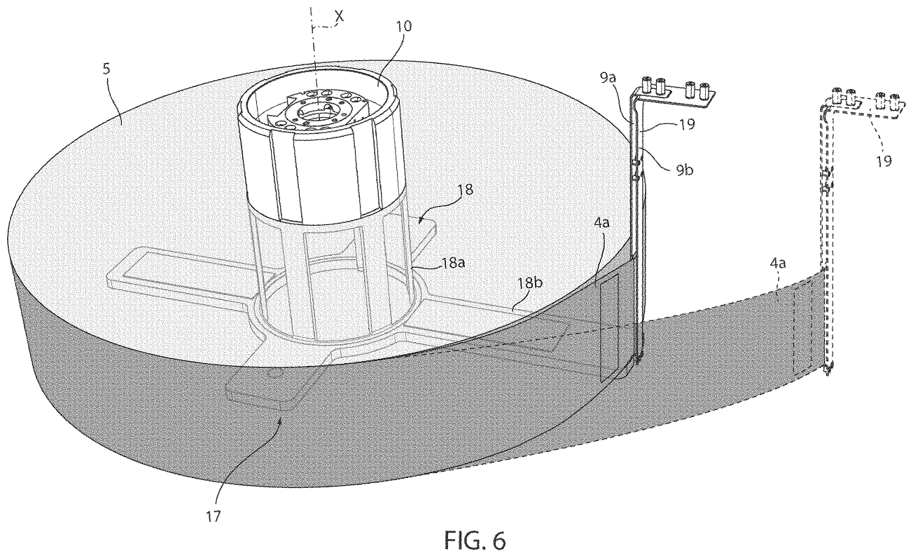

In FIGS. 2, 3 and in the illustration in solid lines of FIG. 6, the gripper 19 is engaged with the support 18. In FIGS. 4, 5A, 5B, and 5C, and in the illustration in dashed lines of FIG. 6, the gripper 19 is disengaged from the support 18.

The preparation of the splicing operation which will be carried out by means of the splicing device 14 requires that the feeding unit supporting the reel of the new web, is loaded on the labelling module 7.

The preparation of the splicing operation which will be carried out by means of the splicing device 14 requires also that the leading portion 4a of the new web adopts an ideal splicing position with respect to the splicing device 14. Therefore, the real splicing position which is adopted by the leading portion 4a shall be as much close as possible to the ideal splicing position, to optimize the correctness of the splicing operation. The leading portion 4a which is indicated in FIGS. 3, 4, 5A, 5B, 5C and 6 belongs to the new web. In FIGS. 5B and 5C, the web leading portion 4a of the new web adopts the real splicing position.

By means of the gripper 19 which is engaged with the support 18 and which can be disengaged from the support 18, the reel 5 of the new web can be loaded on the labelling module 7 with the web leading portion 4a adopting a starting position which make it easier to have at the end of the splicing preparation a real splicing position which is as much close as possible to the ideal splicing position.

A web feeding system 16 is therefore provided which enables a more accurate preparation for the splicing operation.

The gripper 19 is configured for being engaged magnetically with the support 18. In this way, the wear is reduced and the gripper 19 can be more simply disengaged from the support 18.

The support 18 comprises a hub 18a and a radial arm 18b which branches radially from the hub 18a. The gripper 19 is engaged with the support 18 at an axial end of the arm 18b. In this way, the gripper 19 is engaged with the support 18 in a radial position which optimizes the engagement force between the support 18 and the gripper 19, to reduce the risk of accidental loosening of the engagement or the risk of disengagement, during the loading of the feeding unit 17 on the module 7, and simultaneously to make as much easy as possible the subsequent operation of disengagement of the gripper 19.

Therefore, a web feeding system is provided which make it easier a loading of the feeding unit 17 carrying the new web 4, to improve the accuracy of the splicing operation.

The gripper 19 can adopt a closed condition, which can correspond to a gripped condition of the leading portion 4a of the web 4 of the supported reel 5.

The gripper 19 can adopt an open condition, in which the web 4 of the supported reel 5 is not gripped.

From the point of view of the web 4, the web 4 of the supported reel 5 can adopt a gripped condition by means of the gripper 19 adopting the closed condition. In the gripped condition, the respective leading portion 4a of the web 4 is gripped by the gripper 19. Anyway, the gripper 19 can also be closed without gripping any web.

In all the Figures, the gripper 19 adopts the closed condition. Anyway, the gripper 19 in FIG. 5C adopts the closed position but is not gripping any web.

The gripper 19 comprises two claws 19a and 19b, which are indicated in FIG. 6.

In the closed condition of the gripper 19, the claws 19a and 19b are coupled to each other, preferably by means of magnetic effect. In the open condition of the gripper 19, the claws 19a are not coupled to each other. In this way, the gripping action is contactless and can be exerted through the web 4. Therefore, a web feeding system 16 is provided which improves the accuracy of the splicing operation with also a wear minimization.

The gripper 19, in said closed condition, is configured for defining a correct position of the gripped leading portion 4a of the web 4 of the supported reel 5. The correct position is to be considered with respect to a reference system which is integral with respect to the closed gripper 19. Practically, the web can be positioned, for example by an operator, in the correct position of the leading portion 4a, while the gripper 19 adopts the open condition. Afterwards, the gripper 19 can be switched in the closed position. In this way the operator can obtain a situation in which the web leading portion 4a is gripped and is adopting the correct position with respect to the gripper 19 itself. The magnetic nature of the coupling between the two claws of the gripper 19 allows for keeping very stably the leading portion 4a in the correct position during transport of the web towards the real splicing position.

In the reality, when the operator tries to set the correct position, there could be errors.

In the following, “splicing position” means the real splicing position, unless otherwise specified.

The feeding system 16 comprises a positioning device 20. The positioning device 20 is configured for automatically positioning the web leading portion 4a of the supported reel 5 in the splicing position with respect to the splicing device 14.

The positioning device is configured for automatically loading the feeding unit 17 on the labelling module 7, with the gripper 19 being engaged and closed to grip the leading portion 4a of the supported web 4, and with the leading portion 4a of the web 4 of the supported reel 5 adopting the correct position with respect to the gripper 19. In particular, the positioning device 20 can at least pick up the feeding unit 17 from a storage zone 8, and at least release the feeding unit 17 on the labelling module 7. In FIG. 1 and according to the dashed illustration of FIG. 2, the positioning device 20 is picking up the feeding unit 17. According to the solid lines illustration of FIG. 2, the positioning device 20 is releasing the feeding unit 17 on the labelling module 7. In particular, the positioning device 20 can move the feeding unit 17 from the storage zone 8 to the labelling module 7 by grasping the hub 18a of the support 18. Loading the feeding unit 17 can occur also by means of a phase of mounting the feeding unit 17. According to the solid illustration of FIG. 2, the feeding unit 17 can be considered to adopt a mounting position in which the feeding unit 17 is mounted to the labelling module 7.

The positioning device 20 is configured for automatically disengaging the closed gripper 19 from the support 18. The positioning device 20 is configured for automatically disengaging the closed gripper 19 from the support 18, with the web leading portion 4a being in the gripped condition and with the web leading portion 4a adopting the correct position with respect to the gripper 19. In FIG. 3, the positioning device 20 is starting to disengage the gripper 19.

The positioning device 20 is configured for automatically transporting the disengaged and closed gripper 19 to a preestablished position with respect to the splicing device 14. The positioning device 20 is configured for automatically transporting the disengaged and closed gripper 19 to the preestablished position with respect to the splicing device 14, with the web leading portion 4a being in the gripped condition and with the web leading portion 4a adopting the correct position with respect to the gripper 19. By means of the transporting phase, the gripper 19 is transported from a starting position, which can correspond to the position adopted by the gripper 19 when the feeding unit 17 is released to the module 7, to the preestablished position. According to the solids lines illustration of FIG. 2, and in FIG. 3, the gripper 19 adopts said starting position.

In FIGS. 4 and 5A, the positioning device 20 is transporting the gripper 19 towards the preestablished position. In FIG. 5B, the gripper 19 adopts the preestablished position.

The system 16 is configured so that the combination of said correct position of the web leading portion 4a with respect to the gripper 19, and preestablished position of the gripper 19 with respect to the splicing device 14, corresponds to the splicing position of the web leading portion 4a. This means that if the web leading portion 4a adopted the correct position with respect to the gripper 19 and the gripper 19 adopted the preestablished position, the web leading portion 4a would adopt the splicing position. Therefore, in the FIGS. 4 and 5A, the positioning device 20 is transporting the web leading portion 4a towards the splicing position, and in FIG. 5C the web leading portion 4a adopts the splicing position. Thanks to the configuration of the system 16, the splicing position can be more similar or closer to the ideal one, with less risks of errors.

In this way, the preparation of the new web can be at least partly automatized in such a way to optimize the accuracy of said preparation, and reducing the software and/or hardware complexity of the positioning device 20, as the movement of the positioning device 20 can be set based on the preestablished position.

The positioning device 20 can comprise means for locking the hub 18a with respect to the labelling module 7.

The positioning device 20 is configured for opening the gripper 19, that is for switching the gripper 19 from the closed condition to the open condition, after the gripper 19 has reached the preestablished position. In this way, the leading portion 4a of the web 4 can be released to the splicing device 14, while adopting a real splicing position which is as much close as possible to the most ideal splicing position. In FIG. 5B, the gripper 19 is about to be opened but is to be considered still closed.

The positioning device 20 is configured for placing the used gripper 19 in a magazine or storage, after the web leading portion 4a, and therefore the web, has been released by the positioning device 20.

The splicing device 14 comprises at least one pad for supporting the new web. One pad 15 is shown in FIGS. 5A, 5B and 5C.

The preestablished position is with respect to the pad 15. The positioning device 20 is configured so that by opening the gripper 19 the leading portion 4a of the web 4 is released to the pad 15. In FIG. 5B, the gripper 19 adopts the preestablished position and the gripper 19 is closed and is gripping the leading portion 4a of the web 4. In FIG. 5C, the gripper has moved with respect the preestablished position. Between the situation of FIG. 5B and situation of FIG. 5C, the gripper 19 has been opened to release the web leading portion 4a to the pad 15. In the reality, there could be a movement of the web 4 between the situation of FIG. 5B and the situation of FIG. 5C. Anyway, both the FIG. 5B and FIG. 5C can be considered for simplicity as the real splicing position, which, as said above, shall be as much close as possible to the ideal splicing position.

The pad 15 is configured for retaining the leading portion 4a by means of a suction action. Therefore, the pad 15 can be considered a vacuum pad.

Thanks to the above configuration, the positioning of leading portion 4a at splicing device 14 is highly simplified, since the operator only needs to set the correct position of the gripped web 4 with respect to the gripper 19 of the feeding unit 17.

Furthermore, the risk of positioning errors of leading portion 4a into splicing device 14 by the operator, which could highly affect the splicing operation, are sensibly reduced.

This leads to labelling material savings, to avoid undesired stops of labelling machine 1, and ultimately to reduced production times and costs.

Furthermore, the risk of positioning errors of leading portion 4a into splicing device 14 by the operator, which could highly affect the splicing operation, are sensibly reduced.

This leads to labelling material savings, to avoid undesired stops of labelling machine 1, and ultimately to reduced production times and costs.

The positioning device 20 comprises at least one robot. In the embodiment shown, the loading of the feeding unit 17 and the disengagement and transport of the closed gripper 19 are performed by the same robotic head which is carried by a robotic arm. In another embodiment, the robot can comprise a second robotic head which is carried by a second robotic arm. In this case, the disengagement and transport can be carried out by said second robotic head, while the loading is carried out by means of the first robotic head. Each robotic head can be considered an end effector.

The robot can be a cobot (collaborative robot).

Alternatively, the positioning device 20 can comprise:
a guide rail, in particular a guide rail extending from the starting position of gripper 19 to the preestablished position; and
a cart member coupled to the guide rail, which can carry the gripper 19, and slidable along the guide rail for moving gripper 19 from the starting position to the predetermined position at splicing device 14.

The positioning device 20 in this case can comprise a plurality of guide rails, each with a respective cart member which is configured for grasping a gripper 19 in a respective starting position and for transporting the gripper 19 in the preestablished position, by sliding along the respective rail. In this way, a desired number of feeding units 17 can be already loaded on the module 7.

The Applicant has observed that such a configuration allows to further minimize the errors in positioning leading portion 4a at vacuum pad 15 of splicing device 14, while simplifying, at the same time, the controls and the programming for the preparation of the splicing operation.

Anyway, the feeding system 16 comprises a control unit which is configured and programmed for controlling the positioning device 20.

It is known in the field the need for labelling containers 2 of different type, for example containers 2 containing different types of pourable product, e.g. products of different flavours.

In particular, the need is felt for speeding up the changeover of the labelling module or the labelling machine 1 between different type of labels. The type of label includes for example the type of decoration, and/or the size, and or the material of the label.

The positioning device 20 is configured for automatically selecting the specific feeding unit to be loaded on the labelling module 7, based on the specific type of the label by means of which the containers are to be labelled.

The specific type of label can be provided to the positioning device 20 by the control unit, upon input of an operator. For example, the operator can input a list of types of label, defining a production run.

The positioning device 20 can search a reel 5 corresponding to the specific type, by detecting a detectable element which is positioned on the respective feeding unit 17, for example on the respective reel 5. The detectable element cab for example a QR code, a bar code, or any other kind of tag or mark which can be optically or magnetically read or detected.

The positioning device 20 is configured, by means of automatically reading the detectable elements of a plurality of feeding units 17, for automatically selecting the specific feeding unit to be loaded on the labelling module 7, based on a desired type of label.

The positioning device 20 can also be configured for automatically setting the web leading portion 4a in the correct position with respect to the gripper 19.

The positioning device 20 can also be configured for automatically checking whether the web leading portion 4a adopts the correct position with respect to the gripper 19.

The positioning device 20 can also be configured for automatically discard the respective feeding unit 17 or for automatically emitting a warning signal in case the web leading portion 4a does not adopt the correct position with respect to the gripper 19.

The web, as an alternative to the gripper 19, can comprise a transport element which is configured for being integral with the web leading portion 4a of the web 4 of the supported reel 5, and for being coupled with said positioning device 20, so that said positioning device 20 can transport the transport element 20.

In this case, the positioning device 20 is configured for automatically: loading the feeding unit 17 on the labelling module, catching or grasping the transport element, and transporting the transport element to a preestablished position with respect to the splicing device 14. The system 16 is configured so that the preestablished position of the transport element corresponds to the splicing position of the web leading portion 4a.

The detectable element can be integral with the transport element, to reduce the complexity of the system by having less components.

Labelling module 7 can comprise a storage unit 8 for storing a plurality of reels 5. The module 7 can comprise a support unit 10, preferably in the form of two support shafts 10, for supporting in an unwindable manner at least a reel of the web in use and a reel of the new web.

The module 7 can comprise a plurality of guide rollers 11, arranged operatively downstream of support unit 10, and configured to control the unwinding of web 4 off the respective reel 5, to support the web 4 progressively unwound from reel 5 and to guide web 4 along a feed path.

The module 7 can comprise a cutting unit 12 which is arranged downstream of rollers 11, along the feed path, and configured to repeatedly cut web 4 thereby separating a sequence of labels 3 therefrom.

The module 7 can comprise a transfer drum 13, preferably a vacuum drum of the known type, arranged downstream of cutting unit 12, rotatable about a central axis and configured to transfer labels 3 to application station A for the application thereof onto respective containers 2.

In the case of labels 3 that require the use of glue, labelling module 7 further comprises at least one gluing roller (not shown) arranged substantially tangent to transfer drum 13 to spread glue on at least the ends of each individual label 3, before the application thereof.

Clearly, changes may be made to support device 17, web feeding system 16 and the method according to the invention as described herein without, however, departing from the scope of protection as defined in the accompanying claims.

1. A web feeding system for feeding a web of labelling material to a labelling module, comprising:
a splicing device, the feeding system comprising a positioning device for automatically positioning a web leading portion of the web in a splicing position with respect to the splicing device.

2. System The web feeding system according to claim 1, wherein the positioning device comprises at least one robot.

3. The web feeding system according to claim 1, further comprising a web feeding unit, the web feeding unit comprising a support for supporting a reel of the web.

4. The web feeding system according to claim 3, wherein the positioning device is configured for automatically selecting a specific web feeding unit to be loaded on a labelling module based on a desired type of label, which can bewherein the desired type of label is defined by: a decoration, a size, a format, a material, or a combination thereof.

5. The web feeding system according to claim 3, further comprising a transport element configured for being integral with the web leading portion of the web of the supported reel, and for being coupled with the positioning device, so that the positioning device can transport the transport element.

6. The web feeding system according to claim 5, further comprising a detectable element which is integral with the transport element; and
wherein the positioning device is configured, by means of automatically reading detectable elements of a plurality of supported reels, for automatically selecting a specific web feeding unit to be loaded on the labelling module based on a desired type of label, wherein the desired type of label is defined by a decoration, a size, a format, a material, or a combination thereof.

7. The web feeding system according to claim 5,
wherein the positioning device is configured for automatically:
loading the feeding unit on the labelling module;
catching or grasping the transport element; and
transporting the caught or grasped transport element to a preestablished position with respect to the splicing device, wherein the preestablished position of the transport element corresponds to the splicing position of the web leading portion with respect to the splicing device.

8. The web feeding system according to claim 3, wherein the web feeding unit further comprises a gripper for gripping a web leading portion of the web of the supported reel; and
wherein the gripper is configured for being engaged with the support and is configured for being disengaged from the support.

9. The web feeding system according to claim 8, wherein the gripper is configured to be engaged magnetically with the support.

10. The web feeding system according to claim 8, wherein:
the support comprises a central hub and a radial arm, wherein the radial arm branches radially from the hub, the gripper being engaged with the support at an axial end of the radial arm.

11. The web feeding system according to claim 8, wherein the gripper can adopt a closed condition, wherein the closed condition corresponds to a gripped condition of the leading portion of the web of the supported reel, in which the web leading portion is gripped by the gripper, and
an open condition, in which the web of the supported reel is not gripped.

12. The web feeding system according to claim 11, wherein:
the gripper comprises two claws; and
wherein the claws in the closed condition are coupled to each other by means of a magnetic effect, and
wherein in the open condition the claws are not coupled to each other.

13. The web feeding system according to claim 11, wherein the gripper, in said closed condition defines a correct position of the gripped leading portion of the web of the supported reel, said correct position being with respect to the gripper.

14. The web feeding system according to any claim 8,
wherein the positioning device is configured for automatically:
loading the feeding unit on the labelling module, with the gripper being engaged and closed to grip the leading portion of the web of the supported reel;
disengaging the closed gripper from the support; and
transporting the disengaged and closed gripper to a preestablished position with respect to the splicing device.

15. The web feeding system according to claim 14, wherein a combination of a correct position of the web leading portion with respect to the gripper and the preestablished position of the gripper with respect to the splicing device correspond to the splicing position of the web leading portion.

16. The web feeding system according to claim 14, wherein the positioning device is configured for opening the gripper after the gripper has reached the preestablished position.

17. A labelling machine for labelling containers, comprising:
a labelling module comprising a splicing device, the splicing device being configured for splicing a web in use with a new web;
a conveyor for conveying the containers, the labelling machine being configured so that the containers are labelled by the labelling module while being conveyed by the conveyor; and
a feeding system.

18. The labelling machine according to claim 17, wherein:
the splicing device comprises at least one pad for supporting the new web;
the feeding system comprising a positioning device configured to automatically:
load the feeding unit on the labelling module,
catch or grasp a transport element, and transport the caught or grasped transport element to a preestablished position with respect to the splicing device, said
preestablished position of the transport element with respect to the splicing device corresponding to a splicing position of a web leading portion; and
wherein the preestablished position is with respect to the at least one pad.

19. The labelling machine according to claim 17, wherein:
the splicing device comprises at least one pad for supporting the new web;
the feeding system comprising:
a positioning device for automatically positioning a web leading portion of the web in a splicing position with respect to the splicing device,
a web feeding unit, the web feeding unit comprising a support for supporting a reel of the web, wherein the web feeding unit further comprises a gripper for gripping the web leading portion of the web of the supported reel;
wherein the gripper is configured for engagement with the support and disengagement from the support,
wherein the positioning device is configured for automatically:
loading the web feeding unit on a labelling module, with the gripper being engaged and closed to grip the leading portion of the web of the supported reel,
disengaging the closed gripper from the support,
transporting the disengaged and closed gripper to a preestablished position with respect to the splicing device,
wherein the positioning device is further configured for opening the gripper after the gripper has reached the preestablished position, and
wherein the positioning device is configured so that by opening the gripper the leading portion of the web is released to said at least one pad; and
wherein the preestablished position is with respect to the at least one pad.

20. The labelling machine according to claim 18, wherein said at least one pad is configured for retaining said leading portion by means of a suction action.
